(19) United States
(12) Patent Application Publication
(10) Pub. No.: US 2025/0240523 A1
(43) Pub. Date: Jul. 24, 2025

(54) IMAGE INSPECTION APPARATUS, IMAGE INSPECTION METHOD, AND NON-TRANSITORY COMPUTER-READABLE MEDIUM USED FOR IMAGE INSPECTION

(71) Applicant: KONICA MINOLTA, INC., Tokyo (JP)

(72) Inventor: Yuki Hotate, Tokyo (JP)

(73) Assignee: KONICA MINOLTA, INC., Tokyo (JP)

(21) Appl. No.: 18/943,239

(22) Filed: Nov. 11, 2024

(30) Foreign Application Priority Data
Jan. 23, 2024 (JP) 2024-007721

(51) Int. Cl. H04N 23/60; G06T 7/90; H04N 23/71

(52) U.S. Cl. CPC H04N 23/64; G06T 7/90; H04N 23/71

(57) ABSTRACT

;d;s;w;s;f;h;f;a;302An image inspection apparatus includes: a first capturing unit to capture a first image of one surface of a medium; a second capturing unit to capture a second image of the other surface of the medium; and a capturing-signal generator to generate a second capturing-image signal for causing the second capturing unit to capture the second image after a predetermined time has elapsed since a first start-capturing-image signal for causing the first capturing unit to capture the first image.

### CROSS-REFERENCE TO RELATED APPLICATION

This application claims the benefit of priority to Japanese Patent Application No. 2024-007721 filed on 23 Jan. 2024, the disclosures of all of which are hereby incorporated by reference in their entireties.

### TECHNICAL FIELD

The present invention relates to an image inspection apparatus, an image inspection method, and a non-transitory computer-readable medium used for image inspection, and relates to a motor controller to be used when a motor in an image forming apparatus is replaced, for example.

### BACKGROUND OF THE INVENTION

There is an image forming apparatus using a white toner as a fifth color toner in addition to YMCK toners. Additionally, there is black paper as a sheet to feature the effect of the white toner. These increase the added value of a printed matter. In general, a background member of an imaging unit (image sensor) is black to allow for easily capturing a white sheet. In such an image forming apparatus, a trim mark (image for measuring a position of a sheet) which is small enough not to affect image contents is printed at each of four corners of a sheet, and a distance between a sheet edge and the trim mark is measured. This is used to align the image with respect to the sheet during printing.

Here, a case is studied with the image forming apparatus where trim marks are printed with the white toner on a black paper, and then the trim marks are captured. For example, in a case of a job where white papers are mixed with black papers, the black papers may each captured against a black background member. In this case, as the color of the sheet resembles the color of the background member, it is difficult to detect a sheet edge. As the sheet edge can not be detected, the distance from the sheet edge to the trim mark has not been measured.

In order to solve such a problem, an image inspection apparatus of Japanese Patent Application Publication No. 2022-088701 (hereinafter, referred to as Patent Document 1) captures front and back images, and assumes sheet profile information (sheet edge information) of other of the obtained images, based on sheet profile information of other. With this assumption, the image inspection apparatus of Patent Document 1 obtains correction amount for alignment.

### SUMMARY OF THE INVENTION

### Problems to be Solved by the Invention

However, the technique of Patent Document 1 is provided with both a first capturing unit to capture a front image and a second capturing unit to capture a back image, in order to capture images on the front and back. Accordingly, in the technique of Patent Document 1, photosensors are separately provided for detecting a sheet edge. That is, the first capturing unit captures the front image after the first photosensor has detected the sheet edge, and the second capturing unit captures the back image after the second photosensor has detected the sheet edge.

In addition, each of the photosensors detects the sheet edge through polling processing by a central processing unit (CPU). Then, the timing of determining edge detection varies in time. Especially, when the CPU is congested, the variation in time increases. As a result, the technique of Patent Document 1 can not securely align the first image (front image) of one surface of the medium captured by the first capturing unit with the second image (back image) of the other surface captured by the second capturing unit.

The present invention has been devised in view of the above-identified problem, and is intended to provide an image inspection apparatus, an image inspection method, and a non-transitory computer-readable medium used for image inspection which are capable of accurately aligning the first image with the second image.

### Means to Solve Problems

The problems described above are solved by the following inventions.

1) An image inspection apparatus includes: a first capturing unit to capture a first image of one surface of a medium; a second capturing unit to capture a second image of the other surface of the medium; and a capturing-signal generator to generate a capturing-second-image signal for causing the second capturing unit to capture the second image after a predetermined time has elapsed since a start-capturing-first-image signal for causing the first capturing unit to capture the first image.

2) In the image inspection apparatus according to item 1), the first start-capturing-image signal is a signal having variation in time, and the second capturing-image signal has less variation in time than the start-capturing-first-image signal.

3) In the image inspection apparatus according to the item 1), the first start-capturing-image signal is a signal generated through polling control by a CPU executing a program, and the second capturing-image signal is a signal generated by a hardware clock or a real-time OS.

4) In the image inspection apparatus according to item 1), when a process with a higher priority is executed and a CPU resource is congested, the capturing-signal generator generates the second capturing-image signal using a hardware clock.

5) The image inspection apparatus according to item 1) further includes a medium color obtainer to obtain a color of the medium based on medium information, and the capturing-signal generator generates the second capturing-image signal based on a result obtained by the medium-color obtainer.

6) The image inspection apparatus according to item 5) further includes: a first background member provided behind the medium to be captured by the first capturing unit; and a second background member provided behind the medium to be captured by the second capturing unit, wherein the first and second background members are black with a reflectance of 20% or less, and the capturing-signal generator generates the second capturing-image signal when the color of the medium obtained by the medium-color obtainer is black with a reflectance of 20% or less.

7) In the image inspection apparatus according to item 1), the capturing-signal generator includes: a counter-signal generator to start counting, with the first start-capturing-image signal as a starting point; a counter-value holder to hold a predetermined count value; and a comparator to compare the count value in the counter-signal generator with the value in the counter-value holder, wherein the comparator outputs a second capturing-image signal for the second image when a comparison has an opposite result, and the second capturing unit executes scanning in response to the second capturing-image signal.

8) In the image inspection apparatus according to item 7), the counter-value holder obtains a distance between the first and second capturing units and a feeding speed of the medium from the first capturing unit to the second capturing unit, and the count value is determined based on the distance and the feeding speed.

9) The image inspection apparatus according to item 1), further comprises: a first background member provided behind the medium to be captured by the first capturing unit; a second background member provided behind the medium to be captured by the second capturing unit; a sheet feeder to feed a medium; an image forming unit to form an image on the medium; and a medium-color obtainer provided in a medium feeding path between the sheet feeder and the image forming unit and configured to detect a color of the medium, wherein the first capturing unit captures the first image and its background image, the second capturing unit captures the second image and its background image, and when the color of the first background member or the second background member and the color of the medium detected by the medium-color obtainer are black with a reflectance of 20% or less, the second image is captured in response to the second capturing-image signal.

10) In the image inspection apparatus according to item 7), the predetermined count value in the counter-value holder varies according to: a distance between the first and second capturing units; a feeding speed of the medium fed between the first and second capturing units; a size, a basis weight, a thickness, a surface property, a moisture percentage, a resistance, a stiffness, and a type of the medium; an ambient temperature; and an ambient humidity.

11) An image inspection method executed by a control unit of an image inspection apparatus including a first capturing unit to capture a first image of one surface of a medium and a second capturing unit to capture a second image of the other surface of the medium includes: generating a second capturing-image signal for causing the second capturing unit to capture the second image after a predetermined time has elapsed since a first start-capturing-image signal for causing the first capturing unit to capture the first image.

12) A non-transitory computer-readable medium used for image inspection stores a program executed by one or more processors of an image inspection apparatus including a first capturing unit to capture a first image of one surface of a medium and a second capturing unit to capture a second image of the other surface of the medium, and the program, when executed, causes a second capturing-image signal to be generated for causing the second capturing unit to capture the second image after a predetermined time has elapsed since a first start-capturing-image signal for causing the first capturing unit to capture the first image.

### BRIEF DESCRIPTION OF DRAWINGS

The advantages and features provided by one or more embodiments of the invention can be fully understood from the detailed description given hereinbelow and the appended drawings which are given by way of illustration only and thus are not intended to define the limits of the present invention, in which:

FIG. 1 shows a configuration of an image inspection apparatus as a first embodiment of the present invention;

FIG. 2 illustrates a medium being fed with the present invention;

FIG. 3 is a diagram illustrating a configuration inside a capturing-signal generator used in the first embodiment of the present invention;

FIG. 4 is a diagram illustrating a configuration inside a counter-signal generator;

FIG. 5 is a diagram illustrating a configuration inside a capturing-signal generator used in a second embodiment of the present invention;

FIG. 6 is a diagram illustrating a configuration inside a capturing-signal generator used in a third embodiment of the present invention;

FIG. 7 is a diagram illustrating a configuration inside a capturing-signal generator used in a fourth embodiment of the present invention;

FIG. 8 is a flowchart of operation of the capturing-signal generator used in the fourth embodiment of the present invention;

FIG. 9 is a flowchart of a task management unit checking conditions;

FIG. 10 is a first chart indicating a relationship between offset between images of a front surface and a back surface and a frequency of incidents in the fourth embodiment of the present invention;

FIG. 11 is a second chart indicating a relationship between the offset between the images of the front and back surfaces and the frequency of incidents in the fourth embodiment of the present invention;

FIG. 12 is a diagram illustrating configuration of an image inspection apparatus according to a comparative case to the present invention;

FIG. 13 is a diagram illustrating a configuration inside a capturing-signal generator used in the comparative case to the present invention;

FIG. 14 is a first chart indicating a relationship between offset between images of a front surface and a back surface and a frequency of incidents in the comparative case to the present invention; and

FIG. 15 is a second chart indicating a relationship between offset between the images of the front and back surfaces and the frequency of incidents in the comparative case to the present invention.

### DETAILED DESCRIPTION OF EMBODIMENTS

Hereinafter, one or more embodiments of the present invention are described with reference to the drawings. However, the scope of the invention is not limited to the disclosed embodiments. It should be noted that the drawings are merely schematic to the extent that the present invention can be fully understood. Accordingly, the present invention is not limited to those illustrated in the drawings. Additionally, common components and similar components in the drawings are denoted by the same reference signs, and duplicated descriptions thereof are skipped.

An image inspection apparatus of the present invention includes a first capturing unit (11) to capture a first image (e.g., a front side image) of one surface of a medium (7), and a second capturing unit (21) to capture a second image (e.g., a back side image) of the other surface of the medium. The image inspection apparatus according to the invention further includes a capturing-signal generator (50a) to generate a second capturing-image signal (e.g., a capturing-image-interrupt signal) for causing the second capturing unit to capture the second image after a predetermined time has elapsed since a first start-capturing-image signal (e.g., a start-capturing-interrupt-signal) for causing the first capturing unit to capture the first image. At this time, a first background member (13) serving as a background of the first image and a second background member (23) serving as a background of the second image are provided. It is preferable that the first background member and the second background member have distinct colors from each other and have opposite colors (e.g., black and white in a case of a black medium or a set of media with a mixture of white and black papers). In addition, it is preferable that the color of one background member matches the color of the medium. The first and second capturing units are close to each other to such an extent that positional deviation due to feeding can be ignored.

### First Embodiment

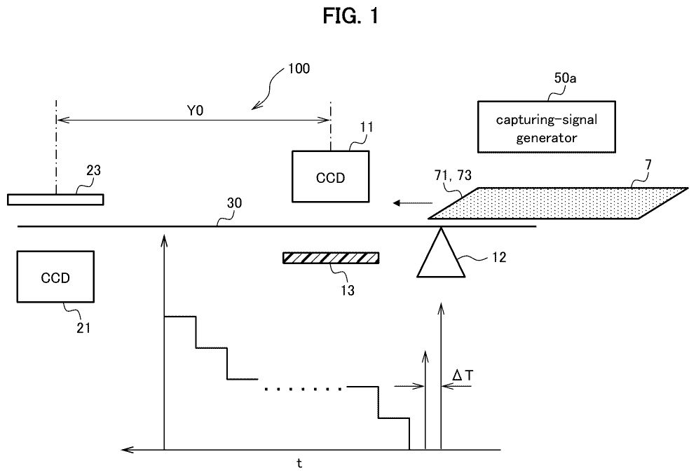

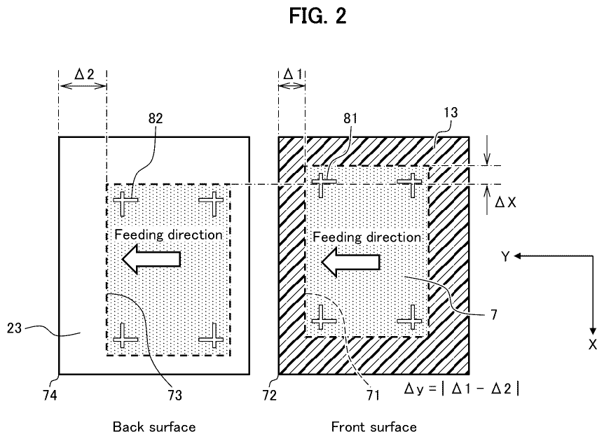

First, a configuration of the image inspection apparatus according to the first embodiment of the present invention is described with reference to FIGS. 1 and 2. An image inspection apparatus 100 inspects an offset in a feeding direction (Y-direction) between images of a front surface and a back surface when a medium 7, such as a leaf, on which images (e.g., images including trim marks 81 and 82 (see FIG. 2)) are formed on both surfaces, is fed in a medium-feeding path 30. That is, the image inspection apparatus 100 inspects an offset Δy=|Δ1−Δ2| between a measured distance Δ1 (see FIG. 2) and a measured distance Δ2 (see FIG. 2). Here, the measurement distance Δ1 (FIG. 2) is a distance between an edge 71 of the medium 7 and a start-capturing position 72 on one surface (front surface). In addition, the measured distance Δ2 ((see FIG. 2) is a distance between an edge 73 of the medium 7 and a start-capturing position 74 on the other surface (back surface). Note that the medium 7 may be a set of media with a mixture of white papers having a white base color and black papers having a black base color.

The image inspection apparatus 100 includes a first photosensor 12, the first capturing unit 11, the first background member 13, the second capturing unit 21, the second background member 23, and the capturing-signal generator 50a. The first capturing unit 11 is a CCD line sensor to capture an image of one surface (front surface) of the medium 7, and captures a first image (e.g., front surface image) of one surface of the medium 7. The first photosensor 12 detects arrived edges 71 and 73 of the medium 7. Thus, timing of imaging by the first capturing unit 11 is determined by a detection signal from the first photosensor 12. The second capturing unit 21 is a CCD line sensor to capture an image of the other surface (back surface) of the medium 7, and captures a second image (e.g., a back surface image) of the other surface of the medium 7. The present embodiment has the timing of imaging by the second capturing unit 21 determined by the capturing-signal generator 50a, based on the detection timing of the first photosensor 12, as described below.

The first background member 13 is a plate member serving as a background for the first capturing unit 11. The first background member 13 is larger than the medium 7 and is provided behind the medium 7 when viewed from the first capturing unit 11. The second background member 23 is a plate member serving as a background for the second capturing unit 21. The first background member 13 and the second background member are different in color from each other, and preferably opposite in color. For example, the first background member 13 may be black, and the second background member 23 may be white. Conversely, the first background member 13 may be white, and the second background member 23 may be black. Thus, when the base color of the medium 7 and the color of the first background member 13 are different from each other, the front surface image can be used to detect the position of the edge 71 of the medium 7. In contrast, when the base color of the medium 7 and the color of the first background member 13 are similar to each other, the back surface image can be used to assume (detect) the position of the edge 71 of the medium 7. Accordingly, one or both of the front and back surface images can be used to detect the edges 71 and 73 of the medium 7, regardless of the base color of the medium 7.

The second background member 23 is larger than the medium 7 and is provided behind the medium 7 when viewed from the second capturing unit 21. Note that The second capturing unit 21 and the second background member 23 are provided downstream in the feeding direction of the first capturing unit 11 and the first background member 13. The first background member 13 and the first capturing unit 11 are separated by a capturing-unit distance Y0 (see FIG. 1) from the second background member 23 and the second capturing unit 21. The capturing-unit distance Y0 is short enough to ignore offset due to feeding.

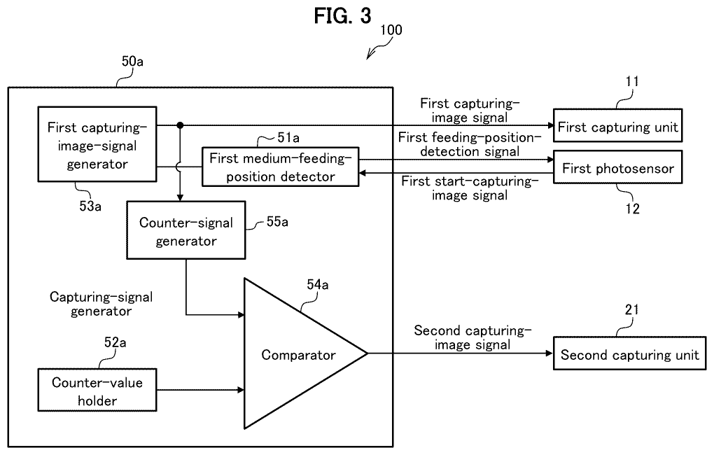

The capturing-signal generator 50a controls the first photosensor 12, the first capturing unit 11, and the second capturing unit 21. The capturing-signal generator 50a includes a central processing unit (CPU) as a controller (not illustrated) and a storage unit (not illustrated). The capturing-signal generator 50a executes an operating system (OS) and an application program stored in the storage unit. This implements functions of the respective units (see FIG. 3). Note that the OS of the present embodiment is assumed to be a general-purpose OS such as Windows (registered trademark) or Linux (registered trademark).

FIG. 3 is a diagram illustrating a configuration inside the capturing-signal generator 50a used in the first embodiment of the present invention. The capturing-signal generator 50a includes functional units of a first medium-feeding-position detector 51a, a first capturing-image-signal generator 53a, a counter-signal generator 55a, a counter-value holder 52a, and a comparator 54a. The first medium-feeding-position detector 51a outputs a first feeding-position-detection signal for driving the first photosensor 12 at a substantially fixed cycle (e.g., every 1 msec) and receiving a detection signal. As a result, the first medium-feeding-position detector 51a receives a detection signal (first start-capturing-image signal) from the first photosensor 12, indicating that the edges 71 and 73 (see FIG. 1) of the media 7 have been detected. As a result, the first medium-feeding-position detector 51a recognizes that the edges 71 and 73 of the media 7 have passed. The first feeding-position-detection signal for driving the first photosensor 12 is generated through polling control by the CPU executing a program under control of the OS, and thus has variation in time. Along with the variation in time of the first feeding-position-detection signal, the first start-capturing-image signal may also have variation ΔT in time (see FIG. 1). For example, when the variation in time is large in the first feeding-position-detection signal, the first feeding-position-detection signal may not be outputted when the edges 71 and 73 of the medium 7 have passed through the first photosensor 12. In this case, the first feeding-position-detection signal is outputted at the timing of the first feeding-position-detection signal in the next cycle. That is, the edges 71 and 73 of the medium 7 are detected by the first photosensor 12 in the next cycle, to have a delay in detection.

The first capturing-image-signal generator 53a uses the first capturing unit 11 in response to receiving the detection signal (first start-capturing-image signal) to capture an image of the front surface of the medium 7 and the background image of the first background member 13. That is, the first start-capturing-image signal is also a signal (first capturing-image signal) for starting capturing the image of the front surface of the medium 7 by the first capturing unit 11. Note that the first feeding-position-detection signal, the first capturing-image signal, and the like may be interrupt signals generated by way of an interrupt.

The counter-signal generator 55a internally generates a constant-frequency clock signal, and counts the clock signal beginning from the timing of receiving the detection signal (first start-capturing-image signal). As the timing of receiving the first start-capturing-image signal is equal to the timing of the first capturing-image signal, the counter-signal generator 55a counts the clock signal in response to the first capturing-image signal.

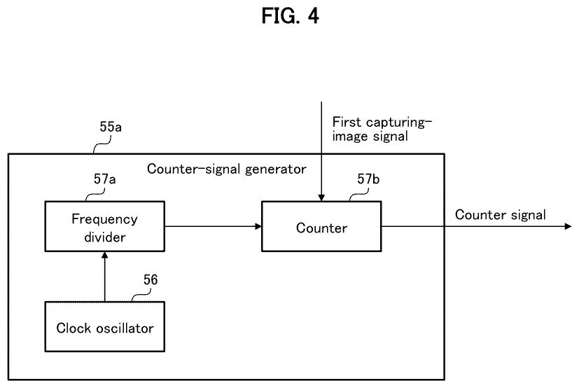

The counter-value holder 52a is a storage unit to hold a value (held value) generated inside the counter-signal generator 55a. This held value depends on the frequency of the clock signal; the capturing-unit distance Y0 (see FIG. 1); the feeding speed, the size, the basis weight, the thickness, the surface property, the moisture percentage, the resistance, the stiffness, and the type of the media; the ambient temperature; and the ambient humidity. Note that the feeding speed of the medium is a feeding speed of the medium 7 fed between the first capturing unit 11 and the second capturing unit 21. The comparator 54a compares the count value (counter signal (see FIG. 4)) in the counter-signal generator 55a with the held value held by the counter-value holder 52a. Then, when the value comparison has an opposite result, the comparator 54a outputs a second capturing-image signal to the second capturing unit 21. This causes the second capturing unit 21 to capture the image of the back surface of the medium 7 and the background image of the second background member 23.

FIG. 4 is a diagram illustrating a configuration inside the counter-signal generator 55a. The counter-signal generator 55a includes a clock oscillator 56, a frequency divider 57a, and a counter 57b. The clock oscillator 56 is a functional unit to generate a clock having a constant frequency. Note that the clock oscillator 56 may use a hardware clock for driving the CPU. The frequency divider 57a is a functional unit to divide the frequency of an output signal from the clock oscillator 56. The counter 57b is a functional unit to count signals outputted from the frequency divider 57a, with the timing of receiving the first capturing-image signal as a starting point. Thus, the counter-signal generator 55a uses the first capturing-image signal (first start-capturing-image signal (see FIG. 3)) to generate a counter signal (a count value by the counter 57b).

As described above, according to the image inspection apparatus 100 of the present embodiment, the first capturing unit 11 captures the image of the front surface and the background image when the first photosensor 12 has detected the edges 71 and 73 of the medium 7. In addition, the second capturing unit 21 captures the image of the back surface and the background image after a predetermined time has elapsed since the first photosensor 12 has detected the edges 71 and 73 of the medium 7. Here, even if there is variation ΔT in time (see FIG. 1) from a timing at which the edges 71 and 73 of the medium 7 pass through the first photosensor 12 to the timing of the edges 71 and 73 being detected, the positions of the edges 71 and 73 of the image of the back surface are correctly recognized, because duration is constant from the timing at which the first capturing unit 11 captures the image of the front surface to the timing at which the second capturing unit 21 captures the image of the back surface. That is, an offset between the images of the front and back surfaces can be obtained.

As a result, the first image is accurately aligned with the second image.

Here, in a case where the base color of the medium 7 is different from the colors of the first background member 13 and the second background member 23, the edges 71 and 73 are clearly copied in the images (images of the front and back surfaces) captured by the first capturing unit 11 and the second capturing unit 21. Thus, the captured image of the back surface can be used to measure distances between the edges 71 and 73 and the trim marks 81 and 82. However, in a case where the base color of the medium 7 and the colors of the first background member 13 and the second background member 23 are similar to each other, the edges 71 and 73 may not be copied in the images captured by the first capturing unit 11 and the second capturing unit 21. According to the present embodiment, though, the edges 71 and 73 of the medium 7 are detected using at least one of the images of the front and back surfaces, regardless of the base color of the medium 7. Accordingly, the distances between the edges 71 and 73 and the trim marks 81 and 82 can be measured.

### Second Embodiment

The capturing-signal generator 50a of the first embodiment uses a general-purpose OS, but may use a real-time OS (Real-Time Operating System or RTOS). This gives a more accurate time since a first medium-feeding-position detector 51b has detected the first start-capturing-image signal (see FIG. 3) until the second capturing unit 21 captures the image of the back surface.

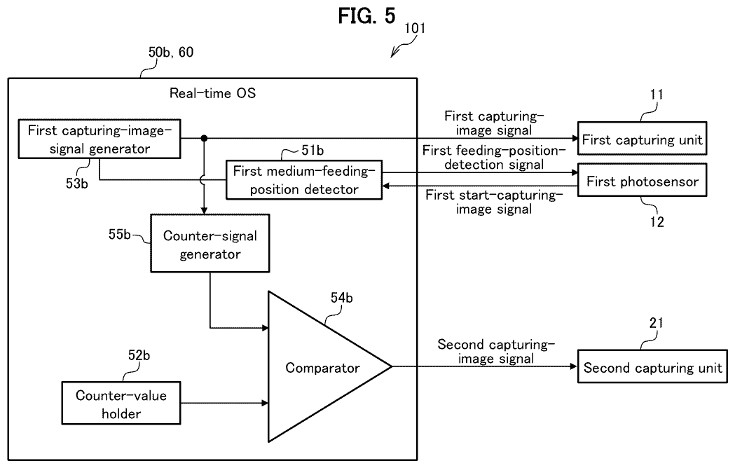

FIG. 5 is a diagram illustrating a configuration inside a capturing-signal generator 50b used in a second embodiment of the present invention. An image inspection apparatus 101 includes the first photosensor 12, the first capturing unit 11, the second capturing unit 21, and the capturing-signal generator 50b. The capturing-signal generator 50b includes the first medium-feeding-position detector 51b, a first capturing-image-signal generator 53b, a counter-signal generator 55b, a counter-value holder 52b, and a comparator 54b, as with the first embodiment described above. However, the capturing-signal generator 50b is different on the point that functional units function under the control of a real-time OS 60. The real-time OS is an OS focusing on fulfilling real-time performance in nano-second order with respect to system requirements, represented by an embedded OS such as ITRON (registered trademark), for example, and includes the real-time Linux (registered trademark).

### Third Embodiment

A general-purpose OS is used in the first embodiment and a real-time OS is used in the second embodiment, but the capturing-signal generator may partly be configured with hardware.

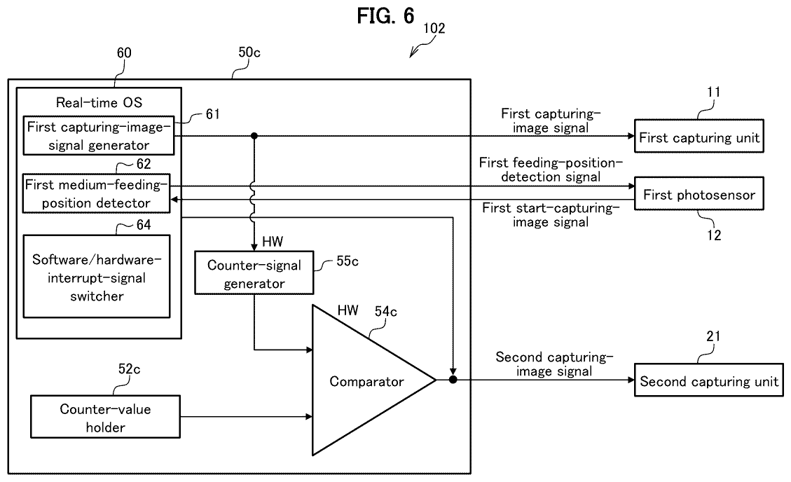

FIG. 6 is a diagram illustrating a configuration inside a capturing-signal generator 50c used in a third embodiment of the present invention. The image inspection apparatus 102 includes the first photosensor 12, the first capturing unit 11, the second capturing unit 21, and the capturing-signal generator 50c. The capturing-signal generator 50c includes a first capturing-image-signal generator 61, a first medium-feeding-position detector 62, a counter-signal generator 55c, a counter-value holder 52c, and a comparator 54c, as with the capturing-signal generators 50a and 50b of the above-described embodiments. However, the first capturing-image-signal generator 61 and the first medium-feeding-position detector 62 are different in the present embodiment on the point that these units function under the control of the real-time OS 60. Another difference is that the counter-signal generator 55c and the comparator 54c are composed of hardware resources. Note that the counter-value holder 52c is a storage unit (hardware resource), as with the above-described embodiments. Note that the hardware resources may be configured to have an oscillation clock in nano-second order cycle with FPGA/ASIC and a frequency divider, for example.

According to the capturing-signal generator 50c of the present embodiment, the counter-signal generator 55c and the comparator 54c are configured with hardware resources. Accordingly, the time since capturing by the first capturing unit 11 until capturing by the second capturing unit 21 is accurate. As the starting capturing by the first capturing unit 11 depends on the first start-capturing-image signal from the first photosensor 12, variation in time of starting capturing by the second capturing unit 21 depends on the variation ΔT in time (see FIG. 1) of the first start-capturing-image signal.

### Fourth Embodiment

The capturing-signal generator 50b of the second embodiment implements the function under the control of the real-time OS 60. Additionally, the counter-signal generator 55c and comparator 54c of the capturing-signal generator 50c according to the third embodiment are configured with hardware resources. A counter-signal generator and a comparator according to the present embodiment are configured with a combination of the real-time OS60 and hardware resources.

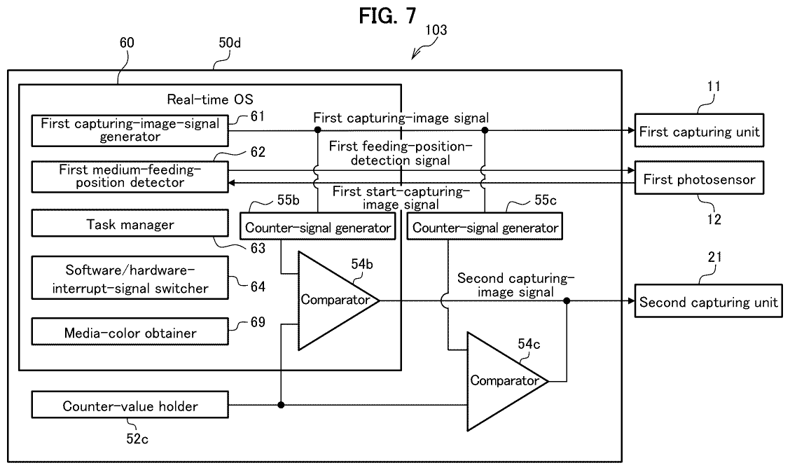

FIG. 7 is a diagram illustrating a configuration inside a capturing-signal generator 50d used in a fourth embodiment of the present invention. The image inspection apparatus 103 includes the first photosensor 12, the first capturing unit 11, the second capturing unit 21, and the capturing-signal generator 50d. The capturing-signal generator 50d implements the functions of the first capturing-image-signal generator 61, the first medium-feeding-position detector 62, the counter-signal generator 55c, the counter-value holder 52c, and the comparator 54c under the control of the real-time OS 60, as with the above-described embodiments. However, the capturing-signal generator 50d further implements the functions of the counter-signal generator 55b and comparator 54b under the control of the real-time OS 60.

That is, the capturing-signal generator 50d includes both hardware resources (the counter-signal generator 55c and comparator 54c) and functional units (the counter-signal generator 55b and comparator 54b) implemented through programs. Another difference is that the capturing-signal generator 50c includes a task manager 63, a software/hardware-interrupt-signal switcher 64, and a medium-color obtainer 69, which implement respective functions under the control of the real-time OS 60.

The task manager 63 determines whether or not processing is congested due to a limited CPU resource or a process with higher priority being executed, for example. The software/hardware-interrupt-signal switcher 64 switches between a set of the counter-signal generator 55c and comparator 54c and a set of the counter-signal generator 55b and comparator 54b, for desired functions. The medium-color obtainer 69 obtains color (hue, saturation, and intensity (density and reflectance) of the medium 7, based on the medium information. The capturing-signal generator 50d determines whether or not to generate a second start-capturing-image signal, based on the medium information and the result of the color obtained by the medium-color obtainer 69. For example, the capturing-signal generator 50d generates the second start-capturing-image signal when the color obtained by the medium-color obtainer 69 is black with reflectance equal to or less than a predetermined value (30%, 20%, 10%, or 5%). In contrast, when the reflectance exceeds the predetermined value, the capturing-signal generator 50d does not generate the second start-capturing-image signal.

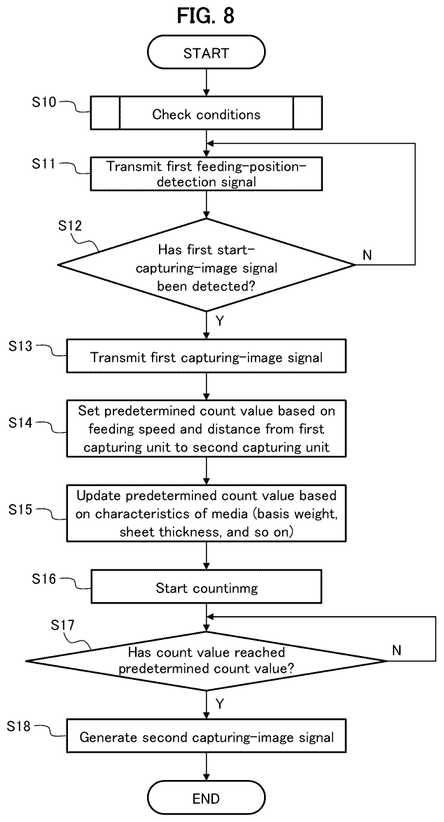

FIG. 8 is a flowchart of operation of the capturing-signal generator 50c used in the fourth embodiment of the present invention. This flow is activated at regular intervals (e.g., 1 msec) when capturing the media 7 is started. First, the task manager 63 checks conditions of the CPU resource and the like (S10).

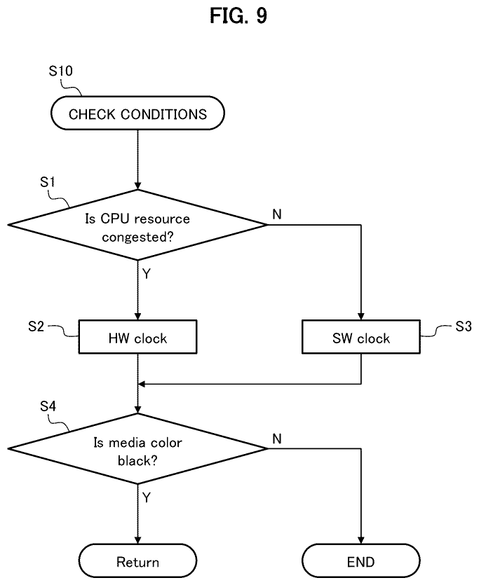

FIG. 9 is a flowchart of the task manager 63 checking the conditions. The task manager 63 determines whether or not the CPU resource is congested (S1). When the CPU resource is congested (Y in S1), the software/hardware-interrupt-signal switcher 64 selects a hardware clock (the counter-signal generator 55c and comparator 54c) (S2). In contrast, when the CPU resource is not congested (N in S1), the software/hardware-interrupt-signal switcher 64 selects a software clock (the counter-signal generator 55b and comparator 54b) (S3).

After processing in S2 or S3, the task manager 63 determines whether or not the color of the media is black (S4). When the color of the medium is white (N in S4), processing ends. That is, when the base color of the medium 7 is white and the color of the first background member 13 is black, the edges 71 and 73 of the medium 7 are clearly copied in the image of the front surface. Thus, the distances between the edges 71 and 73 and the trim marks 81 and 82 are obtained through normal calculation (distance calculation using the images of the front and back surfaces). In contrast, when the color of the medium is black (Y in S4), processing returns to the original flow (see FIG. 8), and the task manager executes processing unique to the present embodiment.

In the flowchart in FIG. 8, the first capturing-image-signal generator 61 (see FIG. 7) transmits a first feeding-position-detection signal to the first photosensor 12 (S11). This causes the first photosensor 12 to be driven to become ready for detecting the edges 71 and 73. After processing in S11, the first medium-feeding-position detector 62 determines whether or not the first start-capturing-image signal has been detected from the first photosensor 12 (S12). When the first start-capturing-image signal has not been detected (N in S12), the determination in S12 is repeated. When the first start-capturing-image signal has been detected (Y in S12), the first capturing-image-signal generator 61 transmits a first capturing-image signal to the first capturing unit 11 (S13), and drives the counter-signal generator 55b or the counter-signal generator 55c. At this time, when the CPU resource is not congested (N in S1 (see FIG. 9)), the counter-signal generator 55b is driven. In contrast, when the CPU resource is congested (Y in S1), the counter-signal generator 55c is driven.

After processing in S13, the counter-signal generator 55b or the counter-signal generator 55c sets a predetermined count value in accordance with the feeding speed and the distance from the first capturing unit 11 to the second capturing unit 21 (S14). After processing in S14, the counter-signal generator 55b or the counter-signal generator 55c updates the predetermined count value based on the properties (such as a basis weight and a sheet thickness) of the medium (S15). After processing in S15, the counter-signal generator 55b or the counter-signal generator 55c starts counting (S16), and determines whether or not the count value has reached a predetermined count value (S17). When the count value has not reached the predetermined count value (N in S17), the counter-signal generator 55b or the counter-signal generator 55c repeats counting. When the count value has reached the predetermined count value (Y in S17), the comparator 54b or the comparator 54c generates a second capturing-image signal (S18), and processing ends.

As described above, according to the present embodiment, the hardware resources (the counter-signal generator 55c and comparator 54c) are used when the CPU resource is congested (Y in S1 (see FIG. 9)), while the programs (the counter-signal generator 55b and comparator 54b) are executed when the CPU resource is not congested (N in S1).

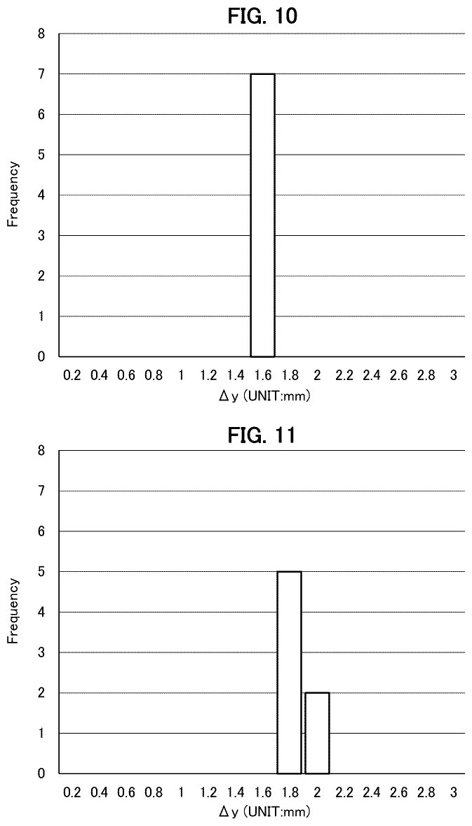

FIGS. 10 and 11 are charts each indicating a relationship between offset between images of the front and back surfaces and a frequency of incidents in the fourth embodiment of the present invention. FIG. 10 illustrates an offset at a left end (end in the minus X-direction), while FIG. 11 illustrates an offset at a right end (end in the X-direction). The offset Δy [mm] between images of the front and back surfaces is calculated as Δy=(Δ1−Δ2). As a position of an edge E1 of the front surface of the medium varies, Δ1 varies and accordingly Δy varies. The frequency of the offset Δy=1.6 mm at the left end is the largest in FIG. 10, while the frequency of the offset Δy=1.8 mm at the right end is the largest and the frequency of the offset Δy=2 mm is the second largest in FIG. 11.

### Comparative Case

In the above-described embodiments, the single first photosensor 12 is used to detect feeding of the medium 7, but more than one photosensor may be used.

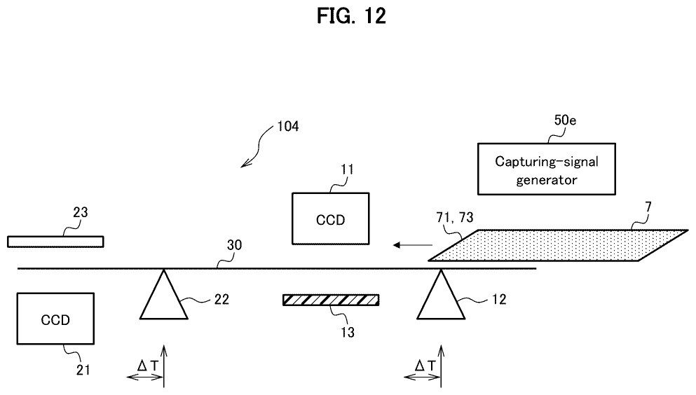

FIG. 12 is a diagram illustrating a configuration of an image inspection apparatus according to a comparative case to the present invention. An image inspection apparatus 104 includes the first photosensor 12, the first capturing unit 11, the first background member 13, the second capturing unit 21, the second background member 23, and a capturing-signal generator 50e, in common with the above-described embodiments. The image inspection apparatus 104 is different on the point of further including a second photosensor 22.

The second photosensor 22 is provided downstream in the feeding direction of the first photosensor 12, and detects the edges 71 and 73 of the medium 7 having arrived thereat. Accordingly, the second photosensor 22 determines a timing at which the second capturing unit 21 captures the image of the back surface of the medium 7.

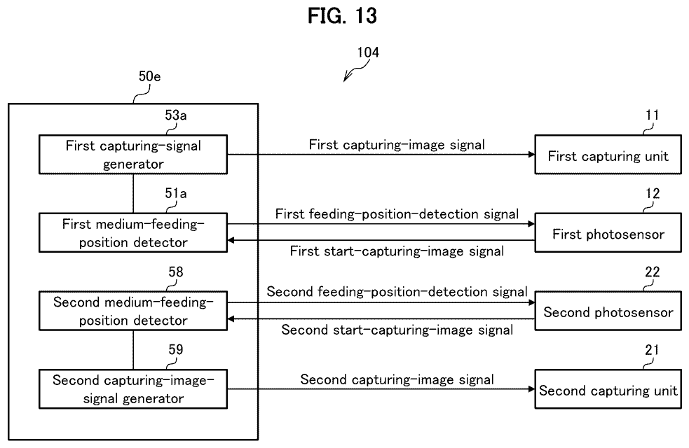

FIG. 13 is a diagram illustrating a configuration inside the capturing-signal generator 50e used in the comparative case to the present invention. The capturing-signal generator 50e includes the first medium-feeding-position detector 51a and the first capturing-image-signal generator 53a, in common with the above-described embodiments. The capturing-signal generator 50e is different on the point of further including a second medium-feeding-position detector 58 and a second capturing-image-signal generator 59. The second medium-feeding-position detector 58 outputs a second feeding-position-detection signal for driving the second photosensor 22 at a fixed cycle (e.g., every 1 msec) and receiving a detection signal. The second medium-feeding-position detector 58 further inputs a detection signal (second start-capturing-image signal) indicating that the second photosensor 22 has detected the edges 71 and 73 (see FIG. 12) of the medium 7. As the second feeding-position-detection signal is a polling signal generated by the CPU executing the program under the control of the OS, there is variation ΔT in time (see FIG. 1). In addition, the second start-capturing-image signal is a signal for starting capturing the image of the back surface of the medium 7 using the second capturing unit 21, and there is variation ΔT in time also at a time of starting capturing the image of the back surface.

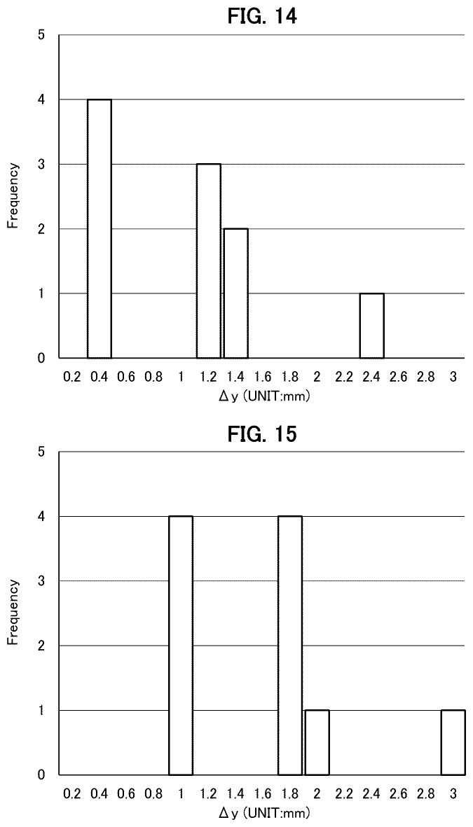

FIGS. 14 and 15 are charts each indicating a relationship between an offset between images of the front and back surfaces and a frequency of incidents in the comparative case to the present invention. FIG. 14 illustrates the offset at the left end, while FIG. 15 illustrates the offset at the right end, as in FIGS. 11 and 12. The offsets Δy having a large frequency are 0.4 mm, 1.2 mm, 1.4 mm, and 2.4 mm in FIG. 14. Likewise, the offsets having a large frequency are 1.0 mm, 1.8 mm, 2.0 mm, and 3 mm in FIG. 15. That is, the offset Δy having a large frequency occurs every 0.8 mm to 1.0 mm. In other words, the offset Δy is to the extent of 2 mm.

In contrast, the offsets Δy of the embodiments are each Δy=1.6 mm at the left end (FIGS. 10) and Δy=1.8 mm to 2.0 mm at the right end (FIG. 11), to have little variation.

### Modifications

The present invention is not limited to the above-described embodiments, and the embodiments can be modified within the scope of the present invention, as the following modifications a) to c), for example.

a) The embodiments are each implemented as an inspection apparatus to inspect an offset between images of the front and back surfaces formed on the medium 7, but the inspection apparatus may include an image forming unit to print an image (form an image) on the medium 7 and a sheet feeder to feed the medium 7. In other words, the image inspection apparatus 100 of each of the embodiments may function as an image forming device. At this time, the medium-color obtainer 69 (see FIG. 7) is provided between the sheet feeder and the image forming unit.

b) In the fourth embodiment, the first background member 13 and the second background member 23 are black, so that when the reflectance of the color obtained by the medium-color obtainer 69 (see FIG. 7) is black having a reflectance equal to or less than the predetermined value, the capturing-signal generator 50d generates the second start-capturing-image signal. However, the present invention is not limited to this, and the capturing-signal generator 50d may generate the second start-capturing-image signal when the color of the media 7 matches or is similar to the color of one of the first background member 13 and second background member 23. At this time, the first background member 13 and second background member 23 are different in color, and preferably opposite in color, from each other.

c) The embodiments are intended to detect an offset in the feeding direction (Y-direction) of the medium 7, but can also detect an offset in the X-direction. In this case, the control unit converts coordinates of apices in the sheet profile information obtained from the image of the back surface into mirror-image positions. Further, the control unit assumes a profile obtained by shifting the profile of the converted apices having been connected with each other, based on the difference between the positions of the medium 7 captured by the first capturing unit 11 and second capturing unit 21, as paper profile information captured by the first capturing unit 11.

Although the embodiments of the present invention have been described and illustrated in detail, the

disclosed embodiments are for the purpose of illustration only and not for limitation. The scope of the present invention should be interpreted by terms of the appended claims.

### LIST OF REFERENCE SIGNS

11: first capturing unit, 12: first photosensor, 13: first background member, 21: second capturing unit, 22: second photosensor, 23: second background member, 30: feeding-medium path, 50a; 50b: capturing-signal generator (control unit), 51a; 51b; 62: first media-feeding-position detector, 52a; 52b; 52c: counter-value holder, 53a; 53b: first capturing-image-signal generator, 54a; 54b: comparator, 55a; 55b; 55c: counter-signal generator, 56: clock oscillator, 57b: counter, 58: second medium-feeding-position detector, 59: second capturing-image-signal generator, 60: real-time OS, 61: first capturing-image-signal generator, 62: first medium-feeding-position detector, 63: task manager, 69: medium-color obtainer, 100; 101; 102; 103; 104: image inspection apparatus (image forming device), 7: medium (sheet, leaf), and 71; 73: edge (medium edge).

What is claimed is:

1. An image inspection apparatus comprising:
a first capturing unit to capture a first image of one surface of a medium;
a second capturing unit to capture a second image of the other surface of the medium; and
a capturing-signal generator to generate a second capturing-image signal for causing the second capturing unit to capture the second image after a predetermined time has elapsed since a first start-capturing-image signal for causing the first capturing unit to capture the first image.

2. The image inspection apparatus according to claim 1, wherein
the first start-capturing-image signal is a signal having variation in time, and
the second capturing-image signal has less variation in time than the first start-capturing-image signal.

3. The image inspection apparatus according to claim 1, wherein
the first start-capturing-image signal is a signal generated through polling control by a CPU executing a program, and
the second capturing-image signal is a signal generated by a hardware clock or a real-time OS.

4. The image inspection apparatus according to claim 1, wherein
when a process with a higher priority is executed and a CPU resource is congested, the capturing-signal generator generates the second capturing-image signal using a hardware clock.

5. The image inspection apparatus according to claim 1, further comprising a medium-color obtainer to obtain a color of the medium, based on medium information, wherein
the capturing-signal generator generates the second capturing-image signal, based on a result obtained by the medium-color obtainer.

6. The image inspection apparatus according to claim 5, further comprising;
a first background member provided behind the medium to be captured by the first capturing unit; and
a second background member provided behind the medium to be captured by the second capturing unit,
wherein the first and second background members are black with a reflectance of 20% or less, and
the capturing-signal generator generates the second capturing-image signal when the color of the medium obtained by the medium-color obtainer is black with a reflectance of 20% or less.

7. The image inspection apparatus according to claim 1, wherein
the capturing-signal generator includes:
a counter-signal generator to start counting, with the first start-capturing-image signal as a starting point;
a counter-value holder to hold a predetermined count value; and
a comparator to compares the count value in the counter-signal generator with the value in the counter-value holder, wherein
the comparator outputs a second capturing-image signal for the second image when a comparison has an opposite result, and
the second capturing unit execute scanning in response to the second capturing-image signal.

8. The image inspection apparatus according to claim 7, wherein
the counter-value holder obtains a distance between the first and second capturing units and a feeding speed of the medium from the first capturing unit to the second capturing unit, and
the count value is determined based on the distance and the feeding speed.

9. The image inspection apparatus according to claim 1, further comprising:
a first background member provided behind the medium to be captured by the first capturing unit;
a second background member provided behind the medium to be captured by the second capturing unit;
a sheet feeder to feed a medium;
an image forming unit to form an image on the medium; and
a medium-color obtainer provided in a medium feeding path between the sheet feeder and the image forming unit and configured to detect a color of the medium, wherein
the first capturing unit captures the first image and its background image,
the second capturing unit captures the second image and its background image, and when the color of the first background member or the second background member and the color of the medium detected by the medium-color obtainer are black with a reflectance of 20% or less, the second image is captured in response to the second capturing-image signal.

10. The image inspection apparatus according to claim 7, wherein
the predetermined count value in the counter-value holder depends on: a distance between the first and second capturing units, a feeding speed of the medium fed between the first and second capturing units; a size, a basis weight, a thickness, a surface property, a moisture percentage, a resistance, a stiffness, and a type of the medium; an ambient temperature; and an ambient humidity.

11. An image inspection method executed by a control unit of an image inspection apparatus including a first capturing unit to capture a first image of one surface of a medium and a second capturing unit to capture a second image of the other surface of the medium, the method comprising:
generating a second capturing-image signal for causing the second capturing unit to capture the second image after a predetermined time has elapsed since a first start-capturing-image signal for causing the first capturing unit to capture the first image.

12. A non-transitory computer-readable medium used for image inspection, storing a program executed by one or more processors of an image inspection apparatus including a first capturing unit to capture a first image of one surface of a medium and a second capturing unit to capture a second image of the other surface of the medium, wherein
the program, when executed, causes a second capturing-image signal to be generated for causing the second capturing unit to capture the second image after a predetermined time has elapsed since a first start-capturing-image signal for causing the first capturing unit to capture the first image.
